(19) United States
(12) Patent Application Publication
(10) Pub. No.: US 2015/0245707 A1
(43) Pub. Date: Sep. 3, 2015

(54) DESK ASSEMBLY

(71) Applicant: William SAAB, Toronto (CA)

(72) Inventor: William SAAB, Toronto (CA)

(21) Appl. No.: 14/633,921

(22) Filed: Feb. 27, 2015

Related U.S. Application Data
(60) Provisional application No. 61/946,379, filed on Feb. 28, 2014.

(51) Int. Cl. A47B 21/03; G06F 1/16; A47B 21/04; A47B 46/00; A47B 1/04; A47B 21/06

(52) U.S. Cl. CPC A47B 21/03; A47B 1/04; A47B 21/06; A47B 21/04; A47B 46/00; G06F 1/1601; A47B 2021/0307

(57) ABSTRACT

A desk assembly is provided for use with a stationary chair. The top of the desk assembly includes a large movable portion that can slide toward a person already seated in the chair. The large movable work surface is sufficiently large to rest both forearms, wrists and hands thereon while working a computer keyboard, to take load off the person's arms, shoulders, neck, and back. The movable portion is free of the weight of other objects. A multi-degree-of-freedom display is independently mounted to stationary structure of the desk. The desk has auxiliary structure hr supporting peripheral devices, such as a printer. The desk has compartments that are exposed when the movable surface is moved to the open position, but that are otherwise concealed. The desk has drawers close to the chair that open on a vertical axis pivot. The desk has an electrical connections suite.

This application claims the priority of U.S. Provisional Patent Application 61/946,379 filed Feb. 28, 2014, the entirety of the specification and drawings thereof being incorporated by reference.

### FIELD OF INVENTION

This description relates to the field of desks.

### BACKGROUND OF THE INVENTION

Many people have difficulty with mobility, whether in the aftermath of a stroke, because of scoliosis due to arthritis, or many other reasons.

For people with limited mobility, the use of a computer, and, particularly, of the internet, may be an important link with the world. However, fir many people with limited mobility, the mere act of having to sit down or stand up at a desk is access-limiting. Existing furniture may presume a level of agility and mobility that riot all persons have. Not all persons have the leg strength to cause a chair mounted on rollers to move under a desk. For those persons, it may be more practical for the desk, or the working surface of the desk, to be movable toward (and away) from the user, rather than the other way around. It may be desirable to employ a desk that accommodates a stationary, or limited mobility, user.

### SUMMARY OF INVENTION

The following summary may introduce the reader to the more detailed discussion to fellow. The summary is not intended to, and does not, limit or define the claims.

In an aspect of the invention, there is a desk assembly. The desk assembly has a desk height, a width, and a depth. The desk assembly has a base having legs. The legs are spaced apart width-wise. The assembly has a body mounted to, and spanning, the legs, a desk top member mounted to the body, the desk top member is translationally movable depth-wise relative to the body. The desk top member has an upper surface having a substantially smooth expanse. The smooth expanse includes a central region and adjacent support regions. The central region is at least as large width-wise as a computer keyboard and is larger depth-wise than a computer keyboard. The adjacent support regions are sized for supporting an adult forearm. The movable desk top member is free of any printer, free of any display, and free of any CPU.

In a feature of that aspect of the invention, the legs of the desk have one of (a) non-rolling feet; and (b) feet having a lock to prevent rolling motion of the desk assembly. In another feature, the assembly includes an electronic display monitor. The display monitor is fixedly secured to the body whereby the weight of the display monitor bears on the body rather than the movable desk top member. In a further feature, the display monitor has an adjustable mounting, and the adjustable mounting is fixedly secured to the body. In another feature, the desk assembly includes an auxiliary support member supported by the body. In still another feature, the auxiliary support member is a movable table leaf, and the movable desk top member is free of weight loading of, and is unobstructed by, the movable table leaf in a further feature, the movable table leaf is a drop leaf mounted adjacent to the movable desk member and the movable table leaf defines a printer support base.

In still another features, the desk assembly has a stationary desk top member. The movable desk top member is mounted flush with the stationary desk top member. The movable desk top member is movable between a proximate, closed position relative to the stationary desk top member and a distant, open position relative to the stationary desk top member, When the movable desk to member is in the closed position the movable desk top member and the stationary desk top member meet at a gap-less join and co-operate to define a continuous smooth surface.

In another feature, the body includes an internal compartment, and the movable desk top member is movable to govern access to the internal compartment. In a further feature, the internal compartment has an array of divisions. The movable desk top member is movable between a closed position and an open position. When the movable desk top member is in the closed position the internal compartment is concealed. In still another feature, the body has a built-in electrical connection suite that includes at least one of (a) a line power source; (b) a ground line Internet connection; (c) a video feed; and (d) a telephone connection. In a still further feature, the body is cantilevered depth-wise toward the user. In a yet further feature, the legs include feet that stand forwardly proud of the movable desk top member when the movable desk top member is in a retracted position.

In yet another feature, the desk has a set of drawers mounted thereto at a level lower than the movable desk top member, and the set of drawers includes at least one drawer having a pivoting motion about an axis, the at least one drawer being mounted predominantly laterally inboard of said axis.

In another aspect of the invention there is a desk assembly for use in conjunction with a stationary chair. The desk assembly has a desk height, a width, and a depth. It has a base having legs. The legs are spaced apart width-wise and define a stationary datum. There is a body mounted to, and spanning, the legs. A desk top member is mounted to the body, the desk top member being movable depth-wise relative to the body on linear slides. The desk top member has an upper surface having a substantially smooth expanse sized for supporting an adult's forearms while typing at a keyboard. The desk top assembly includes a stationary mounting for a display and a multi-degree of freedom display mounted thereto. The display is mounted independently of the movable desk top member,

In a feature of that aspect of the invention, the legs each include a foremost foot oriented toward the stationary Chair, the legs standing in a vertical plane common thereto. In a first position of the desk top member substantially all of the desk top member lies rearwardly of the plane, away from the chair, in a second position of the desk top member, most of the upper surface of the desk top member lies forwardly of the plane, toward the chair. In another feature the desk top member is a first desk top member. There is also a second desk top member, the second desk top member being stationary. The second desk top member is located farther away from the plane than is the first, desk top member. The first, movable desk top member is larger in the depth-wise direction than is the second, stationary desk top member. The display is mounted to the second desk top member. The first position of the first desk top member is a closed position, and in the closed position the first and second desk top members meet to form a continuous smooth desk top surface. The second position of the first desk top member is an open position. In the second position of the desk top member at least one internal chamber is revealed that is concealed when the first desk top member is in the first position. The smooth desk top surface is located at a height, h, the legs are spaced apart laterally by a width, w; and w is greater than h;

In another feature, the desk assembly includes a set Of drawers mounted downwardly of the smooth desk top surface. The set of drawers is stationarily mounted. The set of drawers lies within the downwardly projected profile of the first desk top member when the first desk top member is in the first position. The set of drawers includes at least one drawer that is mounted on a vertical axis of rotation whereby the at least one drawer opens by pivoting about that axis of rotation. When closed, the at least one drawer lies predominantly laterally inboard of the axis of rotation.

In another feature, there is an auxiliary support structure for supporting a computer peripheral. The auxiliary support structure includes to leaf movable from a retracted position to a deployed position. The auxiliary support structure is mounted to stationary structure of the desk such that the first, movable desk top member is unencumbered by the auxiliary support structure. In a further feature, the desk assembly includes an electrical services suite. In a still further feature, the upper surface of the desk top member is at least one cubit in size depth-wise, and at least two cubits in size width-wise.

### BRIEF DESCRIPTION OF THE ILLUSTRATIONS

These and other features and aspects of the invention may be explained and understood with the aid of the accompanying illustrations, in which:

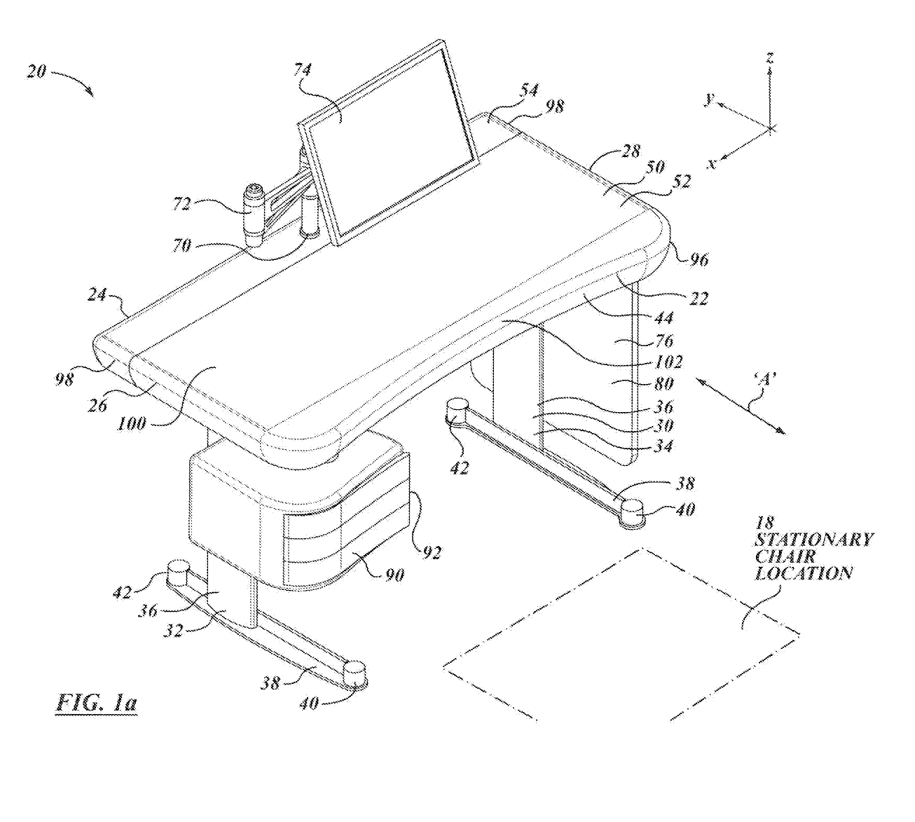

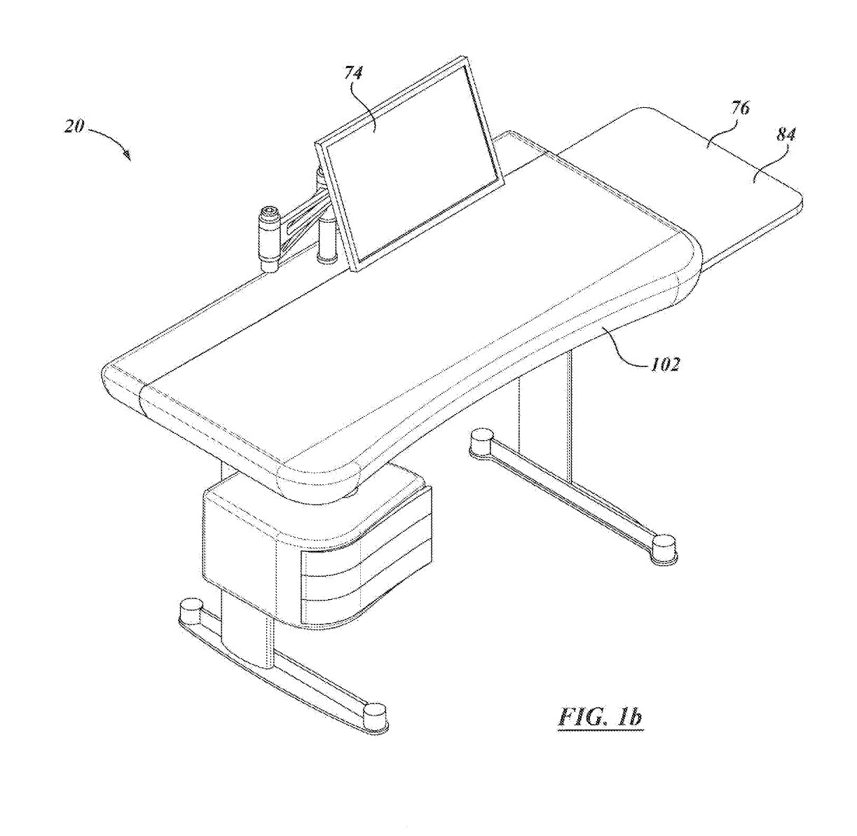

FIG. 1a is a perspective view of a desk according to an aspect of the invention herein, shown front in front, above and to the left, in the closed position;

FIG. 1b is a perspective view of the desk of FIG. 1a with drop leaf raised;

FIG. 1e is a perspective view of the desk of FIG. 1a with drop leaf raised and with the drawers opened or partially opened;

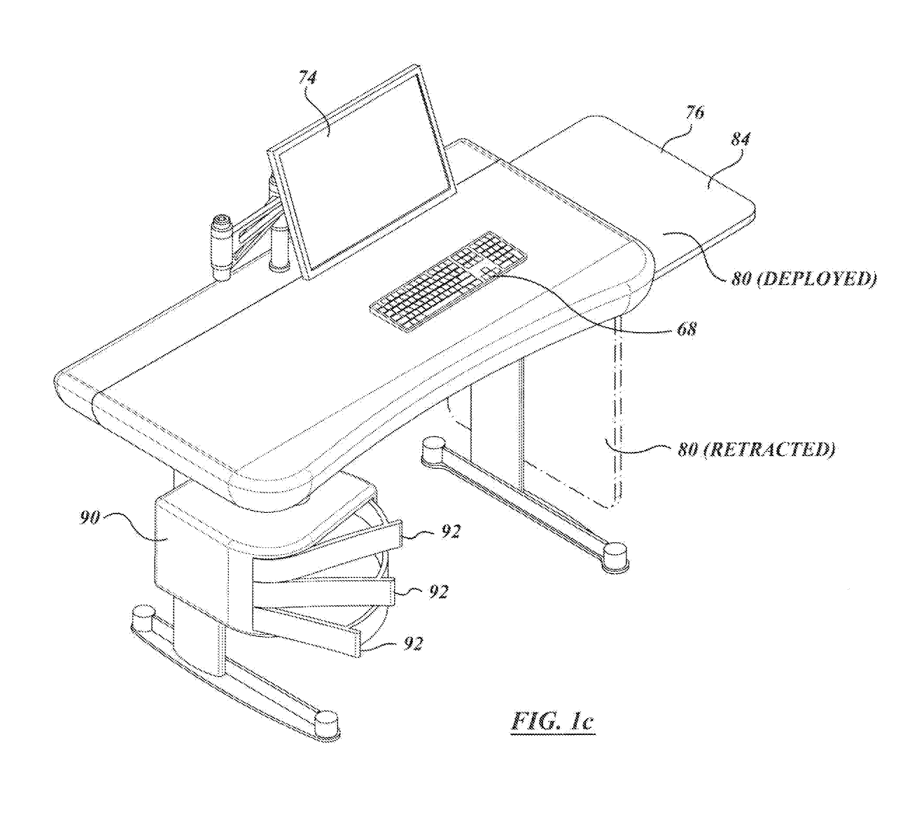

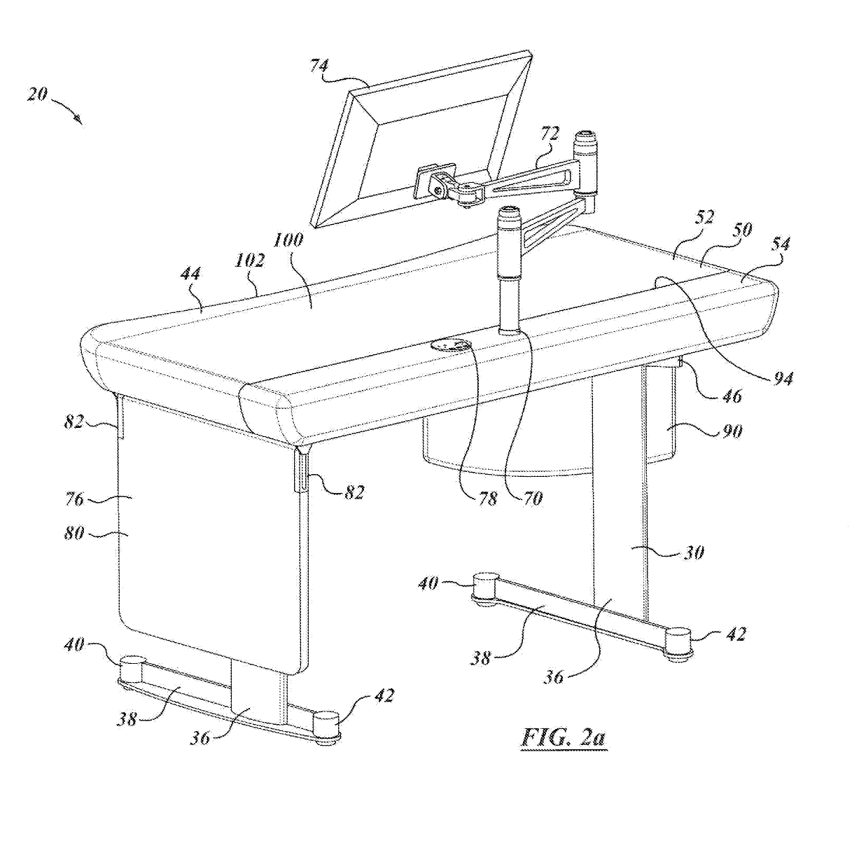

FIG. 2a is an opposite corner perspective view of the desk of FIG. 1a;

FIG. 2b is a view of the desk of FIG. 2a with drop leaf raised;

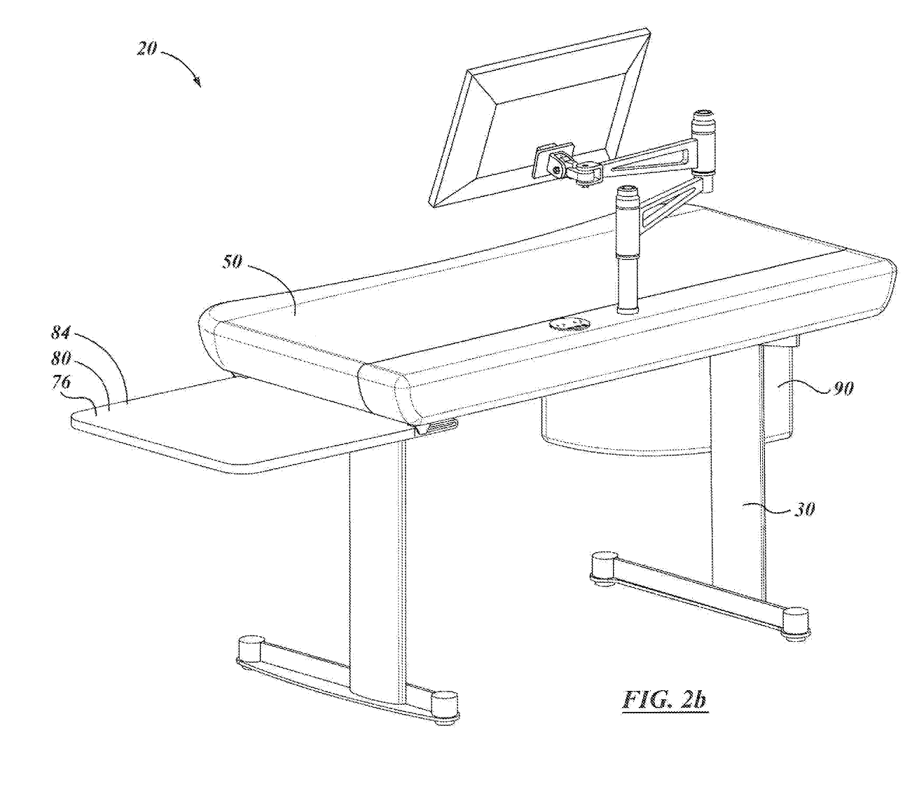

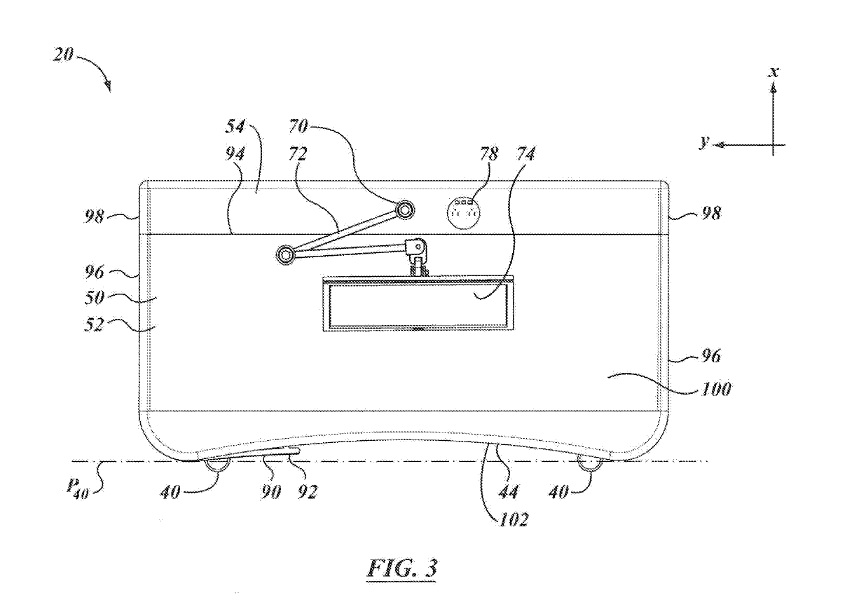

FIG. 3 is a top view of the desk of FIG. 1a;

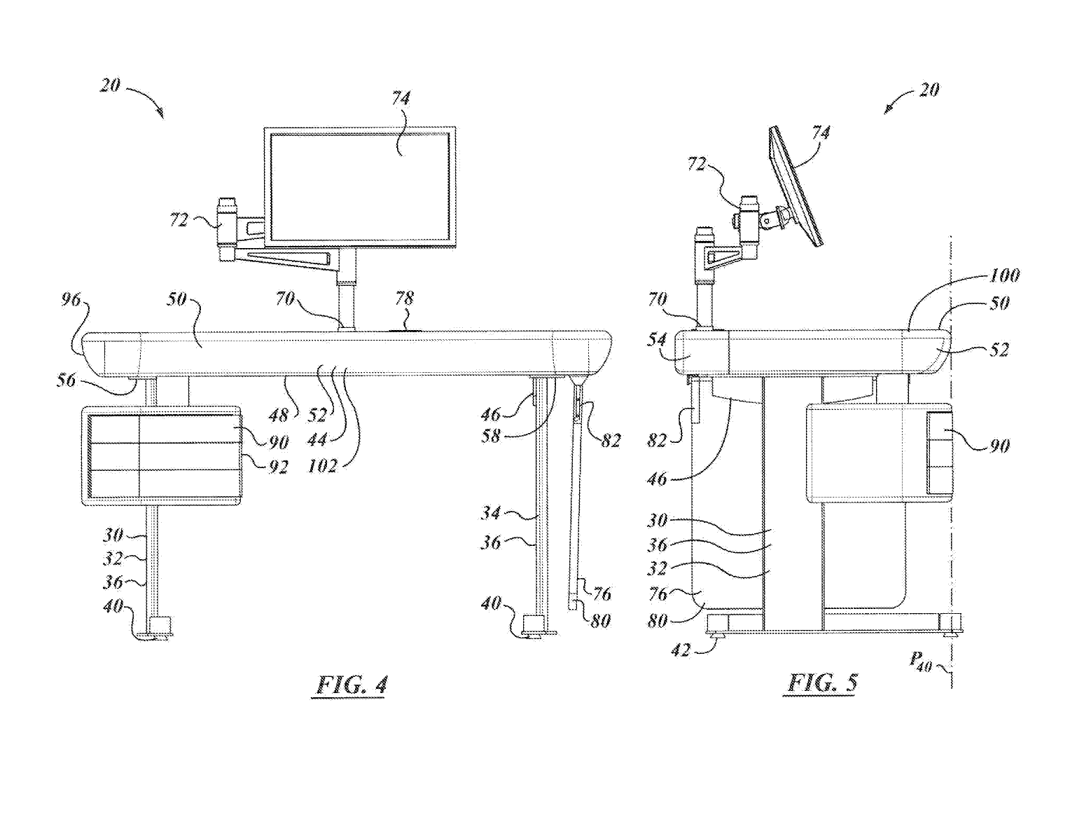

FIG. 4 is a front view of the desk of FIG. 1a;

FIG. 5 is a left hand side, or left, end, view of the desk of FIG. 1a;

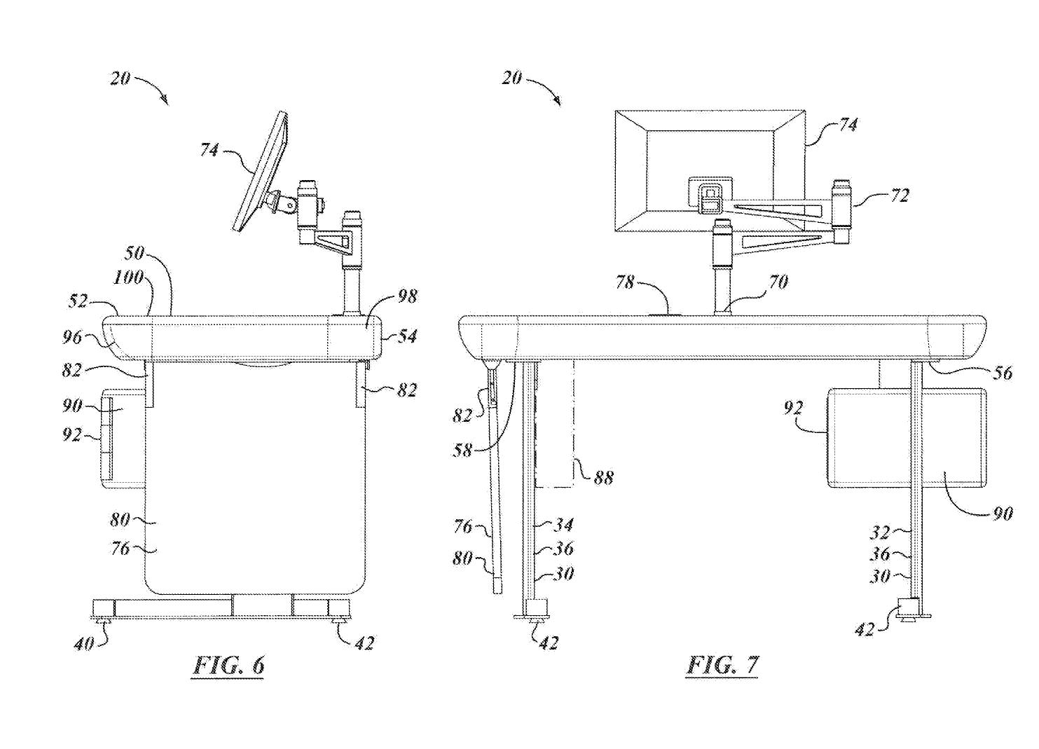

FIG. 6 is a right hand side, or right end, view of the desk of FIG. 1a;

FIG. 7 is a rear view of the desk of FIG. 1a;

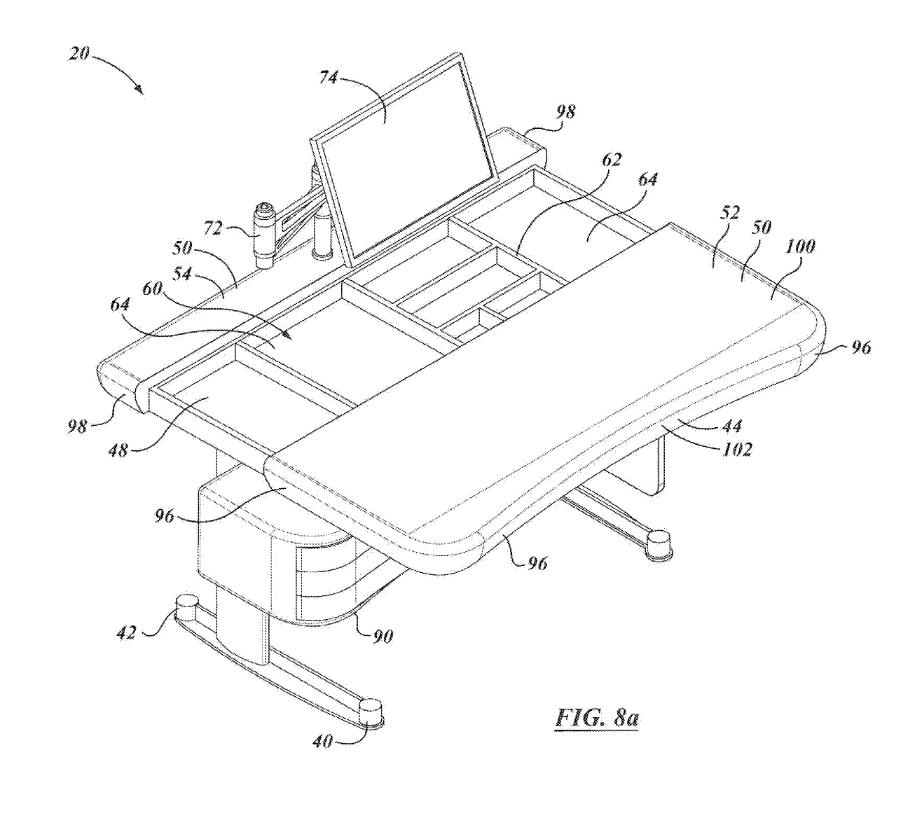

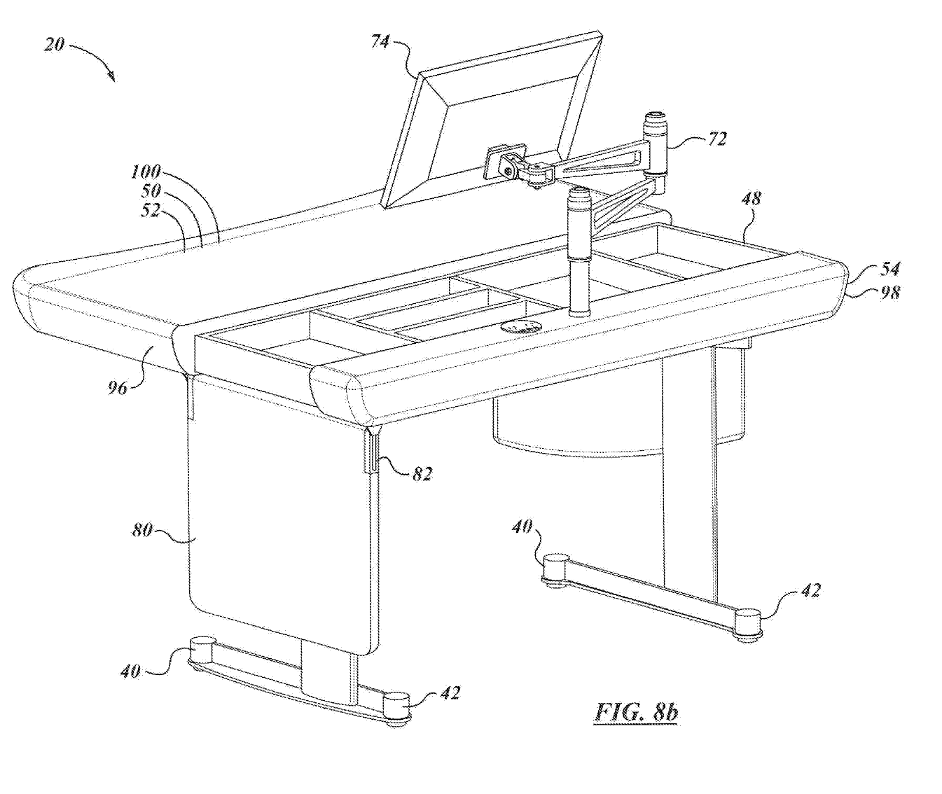

FIG. 8a is a perspective view from in front and above of the desk of FIG. 1a in an open position;

FIG. 8b to is a perspective view from behind and above of the desk of FIG. 8a in an open position;

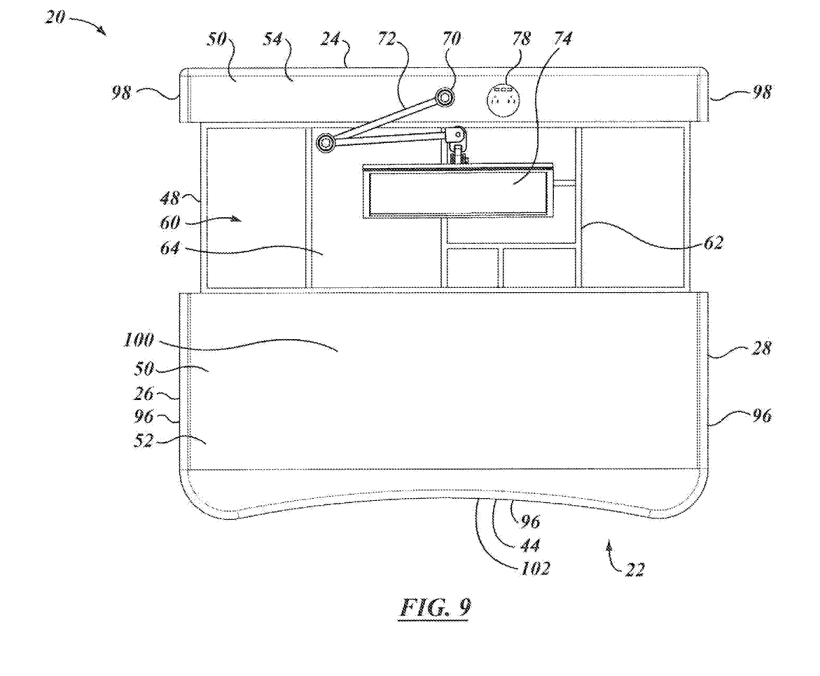

FIG. 9 is a top view of the desk of FIG. 8a;

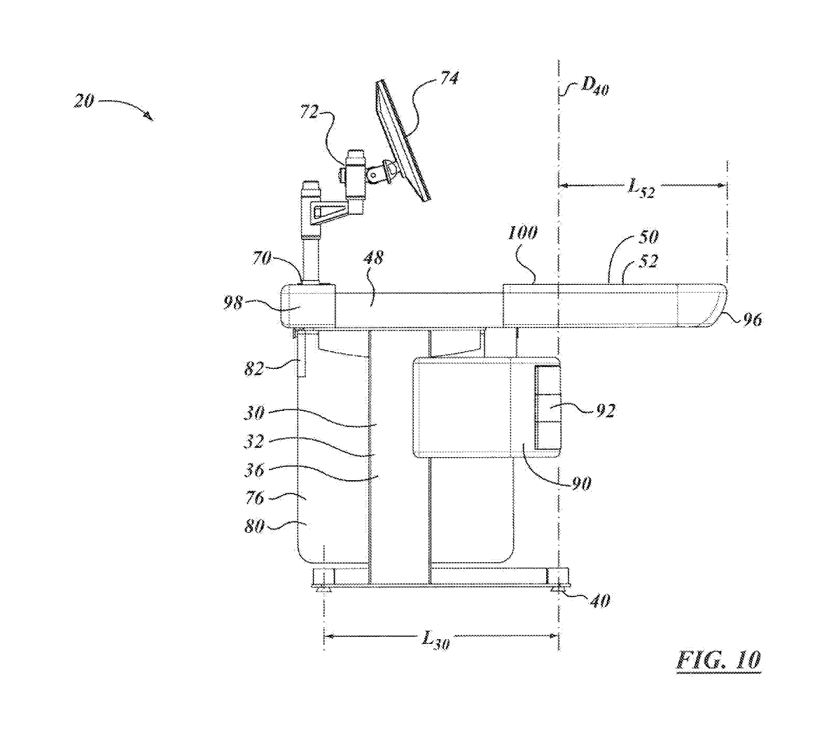

FIG. 10 is as left hand side, or left end, view of the desk of FIG. 8a;

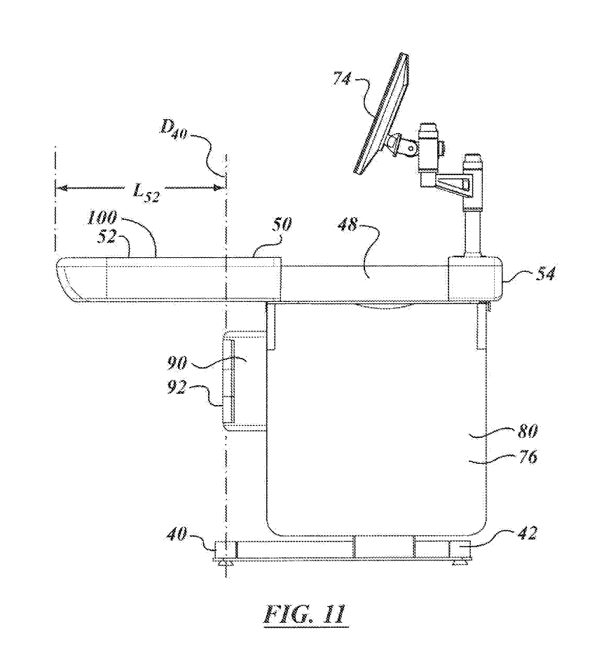

FIG. 11 is a right hand side, or right end, view of the desk of FIG. 8a;

### DETAILED DESCRIPTION

The description that follows, and the embodiments described therein, are provided by way of illustration of an example, or examples, of particular embodiments incorporating one or more of the principles, aspects and features of the present invention. These examples are provided for the purposes of explanation, and not of limitation, of those principles, aspects and features of the invention. In the description, like parts are marked throughout the specification and the drawings with the same respective reference numerals. The drawings may be taken as being to scale, or generally proportionate, unless indicated otherwise.

The scope of the invention heroin is defined by the claims. Though the claims are supported by the description, they are not limited to any particular example or embodiment, and any claim may encompass processes or apparatus other than the specific examples described below. Other than as indicated in the claims themselves, the claims are not limited to apparatus or processes having all of the features of any one apparatus or process described below, or to features common to multiple or all of the apparatus described below. It is possible that an apparatus, feature, or process described below is not an embodiment of any claimed invention.

The terminology used in this specification is thought to be consistent with the customary and ordinary meanings of those terms as they would be understood h a person of ordinary skill in the art in North America. The Applicants expressly exclude all interpretations that are inconsistent with this specification, and, in particular, expressly exclude any interpretation of the claims or the language used in this specification such as may be made in the USPTO, or in any other Patent Office, other than those interpretations for which express support can be demonstrated in this specification or in objective evidence of record, demonstrating how the terms are used and understood by persons of ordinary skill in the art, or by way of expert evidence of a person or persons of experience in the art.

This description discusses desks, desk assemblies and elements of such assemblies. In this discussion it may be helpful to make reference to a Cartesian co-ordinate system. In the embodiments described, the x-axis or x-direction may be taken as being the width-wise, or cross-wise direction of the desk relative to a person sitting in a chair facing the desk. The y-direction may be taken as the horizontal direction running from the front of the desk to the back of the desk, and may also be referred to as the depth-wise direction. The z-direction may be taken as the vertical direction or height direction. The commonly used engineering terms “proud”, “flush” and “shy” may be used herein to denote items that, respectively, protrude beyond an adjacent element, are level with an adjacent element, or do not extend as far as an adjacent element, the terms corresponding conceptually to the conditions of “greater than”, “equal to” and “less than”.

The illustrative Figures show a desk, indicated generally as 20. In this description, the use of desk 20 assumes the existence and adjacent positioning of a chair, whose position is notionally identified at 18. In the combinations of desk and chair, the chair 18 may be as non-rolling chair. That is, the chair has feet that are intended not to roll Or shift when a person is sitting in the chair, or, if having rollers or wheels, it is assumed that the rollers or wheels have been locked in position such as to impede unintended rolling motion or shilling of the chair while desk 20 is being used. Although the chair may be placed in position adjacent to the desk, and may be removable, it is intended that the chair not move relative to the desk, or, more precisely, relative to the fixed position supports, or feet of the desk while someone is sitting in the chair 18

The front of desk 20 is the side of the desk facing, the chair. In the illustrations, the front is designated as 22, the rear is designated as 24. The left side is designated as 26, and the right side is designated as 28.

Desk 20 has an undercarriage, or underframe, or support structure, or base, however it may be termed, this support structure being designated generically as 30. Structure 30 may have the form of a pair of legs, such as left and right hand legs 32, 34. Legs 32, 34 may be spaced apart in the lateral (i.e., width-wise, or x-direction). The spacing of legs 32, 34 may be sufficient to accommodate as wheelchair, the wheel chair having been parked and locked. As a wheelchair may be up to 32 inches wide, the spacing between legs 32, 34 may be at least 32 inches, and may be about 36 inches, or greater than 36 inches. The arms of a wheel chair may typically be about 30 inches high. Therefore, the top working surface of desk 20 may be of comparable height, may be in the range of 27-30 inches, and may in one embodiment be about 29 inches. The lateral spacing of legs 32, 34 may be greater than the vertical height of the working surface of desk 20.

Legs 32, 34 may be made of steel or aluminum, or such other material as may be suitable. Legs 32, 34 may each have the form of a single main post, 36, that is rigidly mounted to, and stands upright from, stretcher, or longeron, or stringer, or foot-beam, indicated as 38. At each end of tile depth-wise extending stretcher 38 there may be a footing, or foot, 40 (front) or 42 (rear). The space between centers of the reactions of feet 40 and 42 is indicated as L₃₀ (FIG. 10). As may be noted, main post 36 may be narrower in the through thickness direction (i.e., the X-direction) than in the depth wise direction, such that it may have a substantial moment arm connection to stretcher 38 such as may aid in resisting moments about the x-axis. The vertical centerline of main post 36 may be closer to rear foot 42 than to front foot 40. in one embodiment the centerline may be in the range of 25% to 50% of that distance, and, in one embodiment is may be in the 30%-35% range, or, generally, about ⅓. The foremost chord of main post 36 may be in the range of 40% to 50% of that distance. That is, at 50% the forewardmost edge of post 36 is midway between rear foot 42 and front foot 40. The desk top may be indicated generally as 50. As may be noted in the side views of FIGS. 5 and 6, in the closed position of desk 20 illustrated, foremost foot 40 stands forwardly proud of the leading edge 44 of desk top 50. That is, if a vertical plane P₄₀ is drawn through the center of reaction of foot 40 of leg 32 and also through the center of reaction of foot 40 of leg 34, that vertical plane passes forwardly of or flush with, the forwardmost edge of desk top 50 when desk top 50 is in the closed position. Expressed differently, desk top 50 lies shy of or flush, or approximately flush with, or tangent to, plane P₄₀. As such, to overturn desk 20 would require a downward force exerted on a moment arm located forwardly of foot 40. In this condition, the entirety of the mass of desk 20 lies behind plane P40, and the center of mass lies far behind plane P₄₀. In another embodiment, at least 90% of the mass of desk 20 lies behind plane P₄₀ when desk 20 is in the closed position.

At their uppermost ends main posts 36 have spreader arms 46 which support the body 48 of desk 20. In some embodiments, main posts 36 may be linked by frame members, whether made of metal, such as steel or aluminum, or wood, or such other material as may be. In the embodiment shown, the lateral linking member is the body 48 itself. Body 48 may be made of wood, such as maple, oak, cherry, and so on.

Body 48 carries desk top 50. Desk top 50 may have a first portion, or member, 52, and a second portion, or member, 54. Desk top member 52 may be a movable member. Desk top member 54 may be as stationary member. That is, desk top member 52 may be mounted to body 50 on a set of slides (hidden from view). The bottom edge of slides 56 and 58 are indicated in FIG. 4. The slides may be metal slides with hearing races. The slides may include nylon rollers, or steel rollers. Body 48 is, in essence, a laterally extending beam. Movable desk top portion 52 can be moved from a first, or closed position, in which it is proximate to stationary desk top portion 54, to a second, open, or distant position in which it is moved away from stationary desk top portion 54. As can be seen in FIG. 9, when movable desk top portion 52 is in the “open” position, it reveals a hidden or concealed compartment for compartments) generally indicated, as 60. Compartment 60 may have an array of internal dividers 62 subdividing the internal chamber or space or accommodation into a plurality of smaller spaces or niches. One such niche or accommodation 64 ma be of a size to accommodate a lap-top computer, or an I-pad, or other reader-sized electronic device. Other spaces may accommodate a calculator, or pens, books, an additional hard drives, electronic memory devices, or other materials such as may be. Desk 20 may have a lock (not shown) such as may be secured by a manual key. A keyboard 68, which may previously have been stored in one of the concealed compartments, is shown placed on desk top 50. One may note that movable desk top member 52 is much larger than keyboard 68, that keyboard 68 may be placed in a variety of positions on member 52, as the user may find comfortable, and that desk top member 52 is much larger than keyboard 68, being both more than three times its size in the depth (y-direction) and more than three times its width (x-direction). As such, desk top member 52 has room not only to support keyboard 68, but also ample room to support the forearms, wrists, and hands, (and a significant portion of the upper body weight) of the person using the keyboard.

Stationary desk top member 54 may extend along the rearward or rearmost margin of body 48, and may extend across all, or substantially all, of the width of desk 20. This need not be so. However, where it is intended that members 52 and 54 may meet flush at both lateral sides, and also flush along their top surfaces and it is convenient that it be so, such that, when closed items 52 and 54 present a continuous smooth planar table top or desk. top. Stationary desk top member 54 is fixed in position not only to body 20, but also to relative to the support structure of main posts 36 and feet 40 and 42. Stationary member 54 has a monitor mounting fitting 70 fixedly mounted thereto. An articulated monitor support. structure, such as a multi-degree-of-freedom articulated arm 72 may be seated in fitting 70, and may carry a monitor, such as may be a flat screen display 74. In this arrangement, the entire vertical loud of display 74 is carried through stationary member 54 and body 50 into legs 32, 34. None of the vertical load passes into movable, desk top portion 52. Furthermore, display 74 is independently movable relative to movable desk top portion 52. That is, display 74 can be positioned by a person who is standing, or who is not necessarily seated at desk 20. That person need not be the person using desk 20, but may be an assistant or other person. Furthermore, once positioned, display 74 may stay in the selected position and may remain there without regard to the movement of movable desk top portion 52 or the comings and goings of any person using desk 20. While in some embodiments articulated arm 72 may be manually adjusted, in one embodiment, articulated arm 72 may be automated, i.e., it may be electrically controlled and driven, either by a manual device such as a track ball, arrow keys on a key-board, a joystick or other means, or may be voice operated, such as not to require a lifting ability or physical agility on the part of the user of desk 20. Articulated aim 72 may be programmable to remember a given position or positions such as may correspond to settings associated with a particular user.

Stationary desk top portion 54 may also have., or include, a services module, or suite, such as may collect in one place an array of interconnections such as electrical power from a household supply, and several outlets to power the computer, monitor, printer and other peripherals, such as may be a 120 VAC 60 Hz power supply, for example; a telephone connection, an internet connection, a connection to a video or other electronic signal feed, an optical fiber connection, a modem connection, and so on. Once again, by gathering services in one location, it may be that by doing so none of the various cables or connections that might otherwise be loose may entangle or encumber, or otherwise interfere with the motion or function of movable desk top portion 52.

Desk 20 may also include one or more auxiliary support structures 76. In the embodiment shown, auxiliary support structure 76 may have the form of a platform, or carrier, or frame, or shelf such as a drop-leaf 80. As shown, drop leaf 80 is pivotally mounted to body 50, and is movable between a retracted or lowered, or hanging position, as shown in FIGS. 1a and 4, and a raised, extended, or deployed position, as shown in FIGS. 1b and 2b. In the raised position, drop leaf 80 is raised by pivoting it about the pivot hinge, and then sliding the shelf along the slides 82 of the binge fitting such that the inward portion of the shell anchors against the underside of the adjacent body structure, with the distal portion 84 cantilevered outward. The cantilevered portion 84 may define support structure for a printer, for example. As before, auxiliary support structure 76 is deployable or retractable independently of motion or position of movable desk top member 52. Neither auxiliary support structure 76 nor any load carried on cantilevered portion 84 bears on, encumbers, places a weight load on, or otherwise interferes with the operation of member 52.

Desk 20 may also include a carriage or frame or basket 88 for as PC CPU tower or hard drive. Basket 88 may hang downwardly from body 50. As with the other elements, basket 88 neither places loads upon, nor encumbers or obstructs operation of movable desk top member 52.

Desk 20 may have a set of drawers 90 that hang, or extend downwardly from, body 50 (and which, alternatively, may in some embodiments be supported directly from support structure 32 or 34 as may be). It may be noted that the contour of drawers 90, seen from above, may fall within, or conform to the profile of desk top 50. Drawers 90 may be rearwardly shy of or approximately flush with or tangent to, plane P₄₀. While in some embodiments linearly sliding drawers may be employed, in one embodiment the drawers may be pivotally mounted on an axis of rotation that is oriented up-and-down, i.e., vertically or predominantly vertically, such that the drawers open by displacement in the circumferential direction rather than by linear translation. Each drawer has a lever, or pull, or tab, or handle, 92 that is radially distant from the hinge or axis of rotation. The axis of rotation may be laterally outboard of the handle, and may be more or less located near or adjacent to the outside edge of desk 20. Each drawer, or tray, is then moved or opened or closed by rotation in the manner of a “lazy Susan”. Operation in this manner may place the handle close to the hand of a person sitting in a chair in front of desk 20.

Movable desk member 52 may extend the full width of desk 20, and may include a surround, or flange, or peripheral wall, or wrap-around edge, or skirt 96 however it may be termed, that is curved downwardly to conceal body 20. That is, skirt 96 extends downwardly around the outside periphery of surface 100, and extends downwardly far enough to hide body 48 from view. Stationary desk member 54 may have the same kind and shape or profile of edging as at 98 to mate flush with the downturned borders of member 52. Similarly, whether on a straight line or a curve, in the closed position members 52 and 54 may meet at a join that is flush and gapless, so that in the closed position it may not be evident that the two parts separate.

The top portion or surface 100 of movable desk portion 52 may be of full width and more than half the front-to-back depth of desk 20. Surface 100 defines a work surface. That work surface is intended to be large. Past desks have used Concealed pull-out keyboard trays, as in U.S. Pat. No. 8,276,523, of Miller. Miller refers to his item 17 as a “keyboard support platform”, which identifies as problem with the apparatus: it supports the keyboard, not the user's hands and arms. That is, for a person of limited mobility, or of motion or body support difficulties, or arthritis, or repetitive strain injuries, an apparatus such as Miller does not permit the user to rest even their arms on the desk while typing, and clearly is not intended to permit a person to place a significant portion of the user's body weight on the keyboard support. Such an arrangement may become very tiring and painful for a user, often quite quickly. Yet users may wish to spend many hours at their keyboard during the day.

By contrast, desk 20 provides a central working surface area, which may be considered generally to be in front of the user's chair, plus ample depth to place the keyboard sufficiently far onto surface 100 depth-wise that the user's forearms may be substantially entirely supported by surface 100, taking the weight off the user's shoulders, neck, and back. The center of surface 100 where the keyboard may be placed may be considered a central region, and the regions adjacent to the keyboard, upon which a user may rest his or her arms may be considered as adjacent support regions.

In the depth direction, surface 100 is more than three times the size of a typical computer keyboard. It is sufficiently large to carry either a conventional keyboard or a lap top, with room remaining for the users to rest their arms and a portion of their upper body weight on surface 100. For the purposes of description herein, the length of a person's arms from elbow to wrist may be approximately 1 ft., and from elbow to finger-tips may be approximately 20 inches. In classical terms, this measure is defined as a cubit. The length of a forearm may then be taken as roughly 1 ft, or approximately double the extent of a typical “qwerty” typewriter keyboard. Similarly, a typical keyboard may be approximately 18 inches wide, or of comparable extent to the length of the forearm and hand. Surface 100 is more than double a typical keyboard width to provide ample room for a place to rest arms and upper body weight, and, in one embodiment, more than triple. In summary, surface 100 of member 52 is greater than a cubit deep (i.e., in the y-direction) and is greater than two cubits wide (in the x-direction).

Once the user is seated in a non-musing chair facing desk 20, movable desk top portion 52 may be drawn toward the user, rather than the user having to attempt to move the chair under the desk top. A person with reduced mobility may find it difficult to propel a chair under a table, but may have sufficient arm strength to draw a slide-mounted table top toward themselves. In using desk 20, in the initial, or closed position, all of portion 52 lies behind the depth-wise position of foremost feet 40. Once the user is sitting in their chair facing desk 20, the forward edge of member 52 is drawn forward through the vertical plane of feet 40, to a position beyond that plane, up to about half the total depth of member 52, providing a full-width cantilevered support surface for the user, where the cantilever (a) extends forwardly from main port 36; and (b) extends beyond feet 40. Movable desk top portion 52 may have a concave front edge 102 such that the outside portions or regions 104, 106 upon which one may wish to rest one's arms actually curve around the user to some extent. When the user wishes to leave, the user may then push the table top, or desk top member 52, away, again, rather than having to rely on leg strength to move a chair out from under the table, which may be difficult for many people. When movable portion 52 is moved to its fully extended forward position, more than half of movable member 52 lies forward of plane P₄₀. At the full extent of travel, foremost edge 104 lies forward of plane P₄₀ by a distance L₅₂. L₅₂ is less than L₃₀, but may be in the range of ½ to ⅘ of L₃₀. In one embodiment the limit of forward travel L₅₂ may be about 70-80% of L₃₀. Nonetheless, the majority of the weight of desk 20 remains behind plane P₄₀, including relatively heavy elements such as the main support posts which are closer to feet 42 than to feet 40; body 48, drop leaf 80, rearward member 54, and all of the monitor and monitor support structure. The arrangement of weight behind plane P₄₀ may discourage overturning of desk 20 when weight is applied to cantilevered movable member 52 when it is moved to the fully open position.

Desk 20 may incorporate a combination of some or all of the following features:

(a) Desk 20 includes a movable, table top member 52 of the desk 20 slides toward the user in the direction of arrow ‘A’ once the user is positioned, i.e., it is adjustment of the desk, not adjustment of the chair that brings the user closer to the work surface, and the sliding top may be manually adjustable or power operated by a gentle touch, and when the table top is in the closed position, the moving portion and the stationary portion meet at a close tolerance closure;

(b) The top of desk 20, typically the rearward margin thereof 54, has an articulated mounting 72 for a screen 74. The mounting may be manually or power operated.

(c) The desk has an auxiliary support surface 76, such as a drop-leaf wing 80 or a retractable sliding panel, upon which to mount a computer peripheral such as a printer;

(d) Desk 20 has an auxiliary electronic equipment cradle 68, such as an under-side mounted rack for a CPU;

(e) Trip 50 of desk 20 has an electronic connection bus, or module or suite 78 at which a broad range of communications connections can be made.

(f) When the table top 50 is in the open position or condition, it exposes internal storage compartments 60.

(g) Desk 20 has a set of drawers or storage compartments 36 on the opposite side from the from drop leaf wing 80.

The base of the desk 20 is stationary, it is not mourned on rollers, or, if mounted on rollers, they are provided with a locking mechanism to make desk 20 stationary.

What has been described above has been intended illustrative and non-limiting and it will be understood by persons skilled in the art that other variances and modifications may be made without departing from the scope of the disclosure as defined in the claims appended hereto. Various embodiments of the invention have been described in detail. Since changes in and or additions to the above-described best mode may be made without departing from the nature, spirit or scope of the invention, the invention is not to be limited to those details but only by the appended claims.

We claim:

1. A desk assembly, the desk assembly having a desk height, a width, and a depth, said desk assembly comprising:
a base having legs, said legs being spaced apart width-wise;
a body mounted to, and spanning, said legs;
a desk top member mounted to said body, said desk top member being translationally movable depth-wise relative to said body;
said desk top member has an upper surface having a substantially smooth expanse, said smooth expanse including a central region and adjacent support regions;
said central region being width-wise at least as large as a computer keyboard and being depth-wise larger than a computer keyboard;
said adjacent support regions being sized for supporting an adult forearm;
said movable desk top member being free of any printer;
said movable desk top member being free of any display;
said movable desk top member being free of any CPU;

2. The desk assembly of claim 1 wherein said legs of said desk have one of:
(a) non-rolling feet; and
(b) feet having a lock to prevent rolling motion of said desk assembly.

3. The desk assembly of claim 1 wherein said desk assembly includes an electronic display monitor, said display monitor being fixedly secured in said body whereby the weight of said display monitor bears on said body rather than said movable desk top member.

4. The desk assembly of claim 3 wherein said display monitor has an adjustable mounting, and said adjustable mounting is fixedly secured to said body.

5. The desk assembly of claim 1 wherein said desk assembly includes an auxiliary support member supported by said body.

6. The desk assembly of claim 5 wherein said auxiliary support member is a movable table leaf, and said movable desk top member is free of weight loading of, and is unobstructed by, said movable table leaf.

7. The desk assembly of claim 6 wherein said movable table leaf is a drop leaf mounted adjacent to said movable desk member and said movable table leaf defines a printer support base,

8. The desk assembly of claim 1 wherein said desk assembly further comprises a stationary desk top member, said movable desk top member is mounted flush with said stationary desk to member; said movable desk top member is movable between a proximate, closed position relative to said stationary desk top member and a distant, open position relative to said stationary desk top member; and, when said movable desk top member is in said closed position said movable desk top member and said stationary desk top member meet at a gap-less join and co-operate to define a continuous smooth surface.

9. The desk assembly of claim 1 wherein said body includes an internal compartment, and said movable desk top member is movable to govern access to said internal compartment.

10. The desk assembly of claim 9 wherein said internal compartment has an array of divisions; said movable desk top member is movable between a closed position and an open position, and when said movable desk trap member is in said closed position said internal compartment is concealed.

11. The desk assembly of claim 1 wherein said body has a built-in electrical connection suite that includes at least one of (a) a line power source; (b) a ground line internet connection; (c) a video feed; and (d) a telephone connection.

12. The desk assembly of claim 11 wherein said body is cantilevered depth-wise toward the user.

13. The desk assembly of claim 11 wherein said legs include feet that stand forwardly proud of said movable desk top member when said movable desk top member is in a retracted position.

14. The desk assembly of claim 1 wherein said desk has a set of drawers mounted thereto at a level lower than said movable desk top member, and said set of drawers includes at least one drawer having a pivoting motion about an axis, said at least one drawer being mounted predominantly laterally inboard of said axis.

15. A desk assembly for use in conjunction with a stationary chair, the desk assembly having a desk height, a width, and a depth, said desk assembly comprising:
a base having legs, said lags being spaced apart width-wise, said legs defining a stationary datum;
a body mounted to, and spanning, said legs;
a desk top member mounted to said body, said desk top member being movable depth-wise relative to said body on linear slides;
said desk top member has an upper surface having a substantially smooth expanse sized for supporting an adult's forearms while typing at a keyboard;
said desk assembly having a stationary mounting for a display and a multi-degree-of-freedom display mounted thereto, and
said display being mounted independently of said movable desk top member.

16. The desk assembly of claim 15 wherein:
said legs each include a foremost foot oriented toward the stationary Chair, said legs standing in a vertical plane common thereto,
in a first position of said desk top member, substantially all of said desk top member lies rearwardly of said plane, away from the chair; and
in a second position of said desk top member, most of said upper surface of said desk top member lies forwardly of said plane, toward the chair.

17. The desk assembly of claim 16 wherein:
said desk top member is a first desk top member;
there is also a second desk top member, said second desk top member being stationary, said second desk top member being located farther away from said plane than is said first desk top member;
said first, movable desk top member is larger in the depth-wise direction than is said second, stationary desk top member;
said display is mounted to said second desk top member;
said first position of said first desk top member is a closed position of said desk assembly, and in said closed position said first and second desk top members meet to form a continuous smooth desk top surface;
said second position, of said first desk top member is an open position of said desk assembly;
in said second position of said desk top member at least one internal chamber is revealed that is concealed when said first desk top member is in said first position;
said smooth desk top surface is located at a height, h,
said legs are spaced apart laterally by a width, w; and
w is greater than h.

18. The desk assembly of claim 17 wherein:
said desk assembly includes a set of drawers mounted downwardly of said smooth desk top surface;
said set of drawers is stationarily mounted;
said set of drawers lies within the downwardly projected profile of said first desk top member when said first desk top member is in said first position;
said set of drawers includes at least one drawer that is mounted on a vertical axis of rotation whereby said at least one drawer opens by pivoting about that axis of rotation; and
when closed, said at least one drawer lies predominantly laterally inboard of the axis of rotation.

19. The desk assembly of claim 17 wherein further comprising an auxiliary support structure for supporting a computer peripheral, said auxiliary support structure including a leaf movable from a retracted position to a deployed position, said auxiliary support structure being mounted to stationary structure of said desk such that said first, movable desk top member is unencumbered by said auxiliary support structure.

20. The desk assembly of claim 15 wherein said upper surface of said desk top member is at least one cubit in size depth-wise, and at least two cubits in size width-wise.
